(19) United States
(12) Patent Application Publication
(10) Pub. No.: US 2013/0249393 A1
(43) Pub. Date: Sep. 26, 2013

(54) ELECTROLUMINESCENT DEVICE WITH ADJUSTABLE COLOR POINT

(71) Applicants: Dirk Hente, Wuerselen (DE); Céline Catherine Sarah Nicole, Eindhoven (NL); Joseph Hendrik Anna Maria Jacobs, Eygelshoven (NL); Christian Kalkschmidt, Overath (DE)

(72) Inventors: Dirk Hente, Wuerselen (DE); Céline Catherine Sarah Nicole, Eindhoven (NL); Joseph Hendrik Anna Maria Jacobs, Eygelshoven (NL); Christian Kalkschmidt, Overath (DE)

(73) Assignee: KONINKLIJKE PHILIPS ELECTRONICS N.V., EINDHOVEN (NL)

(21) Appl. No.: 13/991,662

(22) PCT Filed: Dec. 6, 2011
(86) PCT No.: PCT/IB2011/055484

§ 371 Date: Jun. 5, 2013

(30) Foreign Application Priority Data
Dec. 9, 2010 (EP) 10194255.5

(51) Int. Cl. H05B 33/08

(52) U.S. Cl. CPC H05B 33/0866; H05B 33/0896
USPC 315/50

(57) ABSTRACT

The invention relates to an electroluminescent device for emitting light having an adjustable color point. An electroluminescent region (1) emits light in response to a lighting current and a heating element (7) applies heat to the electroluminescent region A heating control unit (9) controls the heating element (7) in applying the heat in order to adjust the color point of the emitted light. The color point of the light emitted by the electroluminescent device is dependent on the temperature of the electroluminescent region (1). Since the electroluminescent device comprises a heating element (7) for applying heat to the electroluminescent region (1) and a heating control unit (9) for controlling the heating element (7) in applying the heat, the color point can be adjusted in a simple way by using the heating control unit (9).

### FIELD OF THE INVENTION

The invention relates to an electroluminescent device for emitting light having an adjustable color point. The invention relates further to a method for adjusting the color point of light emitted by an electroluminescent device, a lighting apparatus for generating light as well as to a corresponding lighting method.

### BACKGROUND OF THE INVENTION

US 2009/0273616 A1 discloses an electroluminescent device for emitting light whose color point is able to be set variably. The electroluminescent device comprises at least two electroluminescent regions that are electrically connected in parallel. These at least two electroluminescent regions emit light in different spectral bands, i.e., the emitted light may differ in wavelength or in intensity as a function of a given wavelength. By changing the operating voltage applied two the at least two electroluminescent regions, a light emission can be created with a color point that depends on the mixture of the light emitted by the at least two electroluminescent regions. This approach to adjusting the color point allows for a large degree of variability that results from the use of different electroluminescent regions.

### SUMMARY OF THE INVENTION

It is an object of the present invention to provide an electroluminescent device for emitting light having an adjustable color point, which allows the color point of the emitted light to be adjusted in a simple manner. It is a further object of the present invention to provide a method for adjusting the color point of light emitted by an electroluminescent device, a lighting apparatus for generating light as well as a corresponding lighting method.

In a first aspect of the present invention an electroluminescent device for emitting light having an adjustable color point is presented, the electroluminescent device comprising:

an electroluminescent region for emitting light in response to a lighting current,

a heating element for applying heat to the electroluminescent region,

a heating control unit for controlling the heating element in applying the heat in order to adjust the color point of the emitted light.

Since the color point of the light emitted by the electroluminescent device is dependent on the temperature of the electroluminescent region, and since the electroluminescent device comprises a heating element for applying heat to the electroluminescent region and a heating control unit for controlling the heating element in applying the heat, the color point can be adjusted in a simple way by using the heating control unit.

The invention may be used, for example, in applications of electroluminescent devices that do not require the color point of the emitted light to be variable over a large region of the color space. For example, in an arrangement or array of electroluminescent devices, where a potentially large number of such devices are located next to each other, even slight color point variations, e.g., in the range of a few thousandth of a unit in the CIE xy chromaticity diagram, may be noticeable. In such a case, it is desirable to be able to adjust the color points of the light emitted by some or all of the individual electroluminescent devices in order to reduce the small color point variations that may exist even between different electroluminescent devices from the same production batch.

The electroluminescent device can be, for example, an LED (light emitting diode) device or, preferably, an OLED (organic light emitting diode) device. The electroluminescent region can comprise inorganic or organic materials.

For example, if the electroluminescent device is an LED device, the electroluminescent region can comprise inorganic semiconductor materials, such as gallium nitride (GaN) or indium gallium nitride (InGaN). If the electroluminescent device is an OLED device, the electroluminescent region can comprise a suitable organic compound.

The light emitted by the electroluminescent region in response to a lighting current applied through it is the result of the recombination of electrons with holes, during which process the electrons release energy in the form of photons. The term “lighting current”, as used herein, is intended to denote an electrical current that is applied through the electroluminescent region in order for it to emit light. The intensity of the emitted light, i.e., the quantity of the light quanta, depends on the amount of lighting current applied through the electroluminescent region. The color of the emitted light depends primarily on the materials chosen for the electroluminescent region.

Preferably, the electroluminescent device emits a white light, i.e., the electroluminescent device is, for example, a white LED or a white OLED.

It is preferred that the electroluminescent device comprises two electrodes for applying the lighting current through the electroluminescent region, wherein the heating element comprises a heating power source electrically coupled to one of the two electrodes for applying a heating current through that electrode in order to generate joule heat.

Electroluminescent devices, such as LED devices or OLED devices, typically comprise two electrodes for electrically coupling a lighting current source, preferentially, a constant current source, to the electroluminescent region. The lighting current required for the emission of light is then applied through the electroluminescent region by means of the lighting current source.

Because the two electrodes for applying the lighting current through the electroluminescent region may already be available in an electroluminescent device, they can also suitably be re-used for applying heat to the electroluminescent region in order to adjust the color point of the emitted light. By providing a heating element that comprises a heating power source electrically coupled to one of the two electrodes, a heating current can be applied through that electrode, such that the joule heat resulting from conduction losses within the electrode changes the temperature of the electroluminescent region. The term “heating current”, as used herein, is intended to denote an electrical current that is applied through the electrode to which the heating power source is electrically coupled in order for it to apply heat to the electroluminescent region.

If the heating element comprises a heating power source electrically coupled to one of the two electrodes for applying a heating current through that electrode, the heating control unit is preferably adapted to control the amount of heating current that is applied through the electrode to which the heating power source is electrically coupled. By this means, the heating control element can control the heating element in applying the heat in order to adjust the color point of the emitted light.

It should be noted that because the heating power source is electrically coupled to only one of the two electrodes, the flow of the heating current does not affect the flow of the lighting current.

Preferably, the electroluminescent device is built in a layered structure, i.e., the electroluminescent region as well as the two electrodes are formed as layers and the electroluminescent region is arranged between the two electrodes. Such a layered structure is simple to produce and makes it possible to electrically couple the electrodes to the electroluminescent region over a substantial portion of its surface, resulting in a very uniform light emission over the extend of the electroluminescent region. For the described variation of the color point of the emitted light, this also has the advantage that the heat resulting from conduction losses within the electrode to which the heating power source is electrically coupled can be applied very evenly to the electroluminescent region, resulting in a very uniform variation of the color point over the extend of the electroluminescent region. Moreover, because the thickness of the individual layers, i.e., the electroluminescent region and the electrodes, can be quite small, e.g., in the nanometer range, the thermal coupling between the electroluminescent region and the electrodes can be very good in electroluminescent devices built in a layered structure.

It is further preferred that the electrodes have different electrical resistances, wherein the heating power source is electrically coupled to the electrode having the higher electrical resistance. Because the flow of the heating current through the electrode generates joule heat, i.e., heat that is proportional to the square of the heating current multiplied by the electrical resistance of the electrode, it is preferred that the heating power source is electrically coupled to the electrode that has the higher electrical resistance, because, in this case, the same amount of heat can be generated with a smaller heating current.

For example, if the electroluminescent device is a bottom emitting OLED device, i.e., an OLED devices in which the anode faces a substrate and the light output is at the substrate side, the anode is preferred for the heat generation, because its square resistance is usually higher, e.g., 10 or even 100 times higher, than the square resistance of the cathode. This is due to the fact that in bottom emitting OLED devices, the anode is typically made of electrically conducting, transparent materials, such as indium tin oxide (ITO), which have a higher electrical resistance than pure metals like silver or aluminum, which are typically used for the cathode. Thus, in such an electroluminescent device, the heating power source would preferably be electrically coupled to the anode.

It is preferred that the heating control unit is adapted to control the heating element in applying the heat depending on a temperature vs. color point characteristic of the electroluminescent region. The relation between the temperature of the electroluminescent region and the color point of the light emitted by the electroluminescent region can be described by a temperature vs. color point characteristic, i.e., a characteristic that relates: 1) the temperature of the electroluminescent region, and; 2) the color point of the light emitted by the electroluminescent region for a given lighting current, that is specific to the respective electroluminescent device. For example, for OLED devices, the temperature dependent changes of the color point are typically related to properties of the electroluminescent device, such as the size of the device, the materials that are used and the type of packaging. As such, they are usually substantially equal for all OLED devices in a production batch. By controlling the application of heat to the electroluminescent region depending on the temperature vs. color point characteristic of the electroluminescent region, a desired color point can be set by heating the electroluminescent region to the temperature that corresponds to the desired color point.

For example, in one exemplary application scenario, the color point of an electroluminescent device may be measured after production for a lighting current and a temperature of the electroluminescent region that can be expected in future operation of the electroluminescent device. Knowing the temperature vs. color point characteristic of the electroluminescent region, it can then be determined how much the temperature has to be adjusted in order to reach a given color point target and the heating control unit could control the heating element accordingly. If the heating element comprises a heating power source electrically coupled to one of the two electrodes for applying a heating current through that electrode, the heating control unit could control the amount of heating current that is applied through the electrode to which the heating power source is electrically coupled by using a-priori knowledge about the device specific relationship between the amount of heating current applied through that electrode and the temperature changes induced by it in the electroluminescent region.

It is preferred that the heating control unit can use a linear temperature vs. color point relationship as the temperature vs. color point characteristic of the electroluminescent region. A linear temperature vs. color point relationship may approximate quite well the temperature vs. color point characteristic of the electroluminescent region of various electroluminescent devices, such as, for example, OLED devices.

It is preferred that the electroluminescent device comprises a temperature sensing element for providing a sensed temperature of the electroluminescent region to the heating control unit. Having a temperature sensing element for providing a sensed temperature of the electroluminescent region to the heating control unit makes it possible to provide a closed loop control of the heat applied to the electroluminescent region. In other words, this means that the heating control unit can control the heating element in applying the heat, while—at the same time—receiving the sensed temperature of the electroluminescent region from the temperature sensing element. Because, in this case, the heating control unit can receive a continous feedback from the temperature sensing element, it can easily control the heating element to apply a sufficient amount of heat to the electroluminescent region so that a desired temperature of the electroluminescent region is reached.

In particular, if the heating element comprises a heating power source electrically coupled to one of the two electrodes of the electroluminescent device for applying a heating current through that electrode, the heating control unit can easily control the heating element to apply a sufficient amount of heating current through the electrode to which the heating power source is electrically coupled so that a desired temperature of the electroluminescent region is reached. It is, in this case, not necessary to have a-priori knowledge about the device specific relationship between the amount of heating current applied through that electrode and the temperature changes induced by it in the electroluminescent region.

Moreover, if the temperature vs. color point characteristic of the electroluminescent region, i.e., the characteristic that relates: 1) the temperature of the electroluminescent region, and; 2) the color point of the light emitted by the electroluminescent region for a given lighting current, is known, the feedback from the temperature sensing element to the heating control unit allows for a direct control of the color point by simply heating the electroluminescent region until the temperature that corresponds to the desired color point is reached.

The use of a closed loop control, which is made possible by the provision of a temperature sensing element for providing a sensed temperature of the electroluminescent region to the heating control unit, also has the advantage that the self heating of the electroluminescent device as well as changes in the environment temperature can be taken into account.

It is further preferred that the temperature sensing element is adapted to sense the temperature of the electroluminescent region using a thermometer. The use of a thermometer, such as a thermocouple or a similar device, provides a simple way of sense the temperature of the electroluminescent region. Such devices are inexpensive and directly generate an electrical signal that is indicative of the sensed temperature.

It is preferred that the temperature sensing element is adapted to sense the temperature of the electroluminescent region by measuring for a given lighting current a voltage change across the electroluminescent region and by relating it to the temperature of the electroluminescent region depending on a voltage change vs. temperature characteristic of the electroluminescent region. The advantage of this approach is that the electroluminescent device itself is effectively used by the temperature sensing element for sensing the temperature of the electroluminescent region, so that no additional thermometer, such as a thermocouple or a similar device, has to be integrated into the electroluminescent device. The underlying principle is based on the effect that for a given lighting current the voltage change across the electroluminescent region is strongly dependent on the temperature of the electroluminescent region. Thus, if a voltage change vs. temperature characteristic of the electroluminescent region, i.e., a characteristic that relates: 1) the voltage change across the electroluminescent region for a given lighting current, and; 2) the temperature of the electroluminescent region, is known, measuring the voltage change across the electroluminescent region for a given lighting current then provides a measurement of the temperature of the electroluminescent region. Because the temperature measurement is based on the “build-in” voltage change vs. temperature characteristic of the electroluminescent region, this approach is also called “intrinsic sensing”.

Preferentially, the temperature sensing element is adapted to take aging effects of the electroluminescent region into account by applying an aging correction, as described, for example, in US 2008/0252571 A1, which is herewith incorporated by reference. Such aging effects can be predicted, for example, based on the accumulated lighting current during the operation time of the electroluminescent device.

In another aspect of the present invention a method for adjusting the color point of light emitted by an electroluminescent device is presented, the method comprising:

emitting light in response to a lighting current by an electroluminescent region,

applying heat to the electroluminescent region by a heating element,

controlling the heating element in applying the heat in order to adjust the color point of the emitted light by a heating control unit.

In another aspect of the present invention a computer program for adjusting the color point of light emitted by an electroluminescent device is presented, the computer program comprising program code means for causing an electroluminescent device as defined in claim 1 to carry out the steps of the method as defined in claim 9, when the computer program is run on a computer controlling the electroluminescent device.

In another aspect of the present invention a lighting apparatus for generating light is presented, the lighting apparatus comprising

two or more electroluminescent devices for emitting light having an adjustable color point as defined in claim 1,

a lighting apparatus control unit for controlling the heating control unit of at least one of the two or more electroluminescent devices in order to reduce a variation between the color points of the light emitted by the two or more electroluminescent devices.

Such a lighting apparatus has the advantage that small color point variations, which may exist even between different electroluminescent devices from the same production batch, may effectively be reduced.

The variation between the color points of the light emitted by the two or more electroluminescent devices may be reduced by adjusting the color points to a common color point target, which may be defined, for example, by a rectangular chromaticity window in the CIE xy chromaticity diagram. If the electroluminescent device emits a white light, i.e., if the electroluminescent device is, for example, a white LED or a white OLED, the common color point target may be situated next to the black body line.

In another aspect of the present invention a lighting method for generating light is presented, the method comprising:

emitting light having an adjustable color point by two or more electroluminescent devices as defined in claim 1,

controlling the heating control unit of at least one of the two or more electroluminescent devices in order to reduce a variation between the color points of the light emitted by the two or more electroluminescent devices by a lighting apparatus control unit.

In another aspect of the present invention a lighting computer program is presented, the lighting computer program comprising program code means for causing a lighting apparatus as defined in claim 11 to carry out the steps of the lighting method as defined in claim 12, when the computer program is run on a computer controlling the lighting apparatus.

It shall be understood that the electroluminescent device for emitting light having a adjustable color point of claim 1, the method for adjusting the color point of light emitted by an electroluminescent device of claim 9, the computer program for adjusting the color point of light emitted by an electroluminescent device of claim 10, the lighting apparatus for generating light of claim 11, the lighting method for generating light of claim 12 and the lighting computer program of claim 13 have similar and/or identical preferred embodiments, in particular, as defined in the dependent claims.

It shall be understood that a preferred embodiment of the invention can also be any combination of the dependent claims with the respective independent claim.

These and other aspects of the invention will be apparent from and elucidated with reference to the embodiments described hereinafter.

### BRIEF DESCRIPTION OF THE DRAWINGS

In the following drawings:

FIG. 1 shows schematically and exemplarily an embodiment of an electroluminescent device for emitting light having a adjustable color point

FIG. 2 shows schematically and examplarily an equivalent circuit of the basic elements of an electroluminescent device according to FIG. 1

FIG. 3 shows schematically and exemplarily a color point distribution for a production batch of electroluminescent devices

FIGS. 4 and 5 show schematically and exemplarily a temperature dependency of the color point for varying lighting currents

FIG. 6 shows schematically and exemplarily a temperature vs. colorpoint characteristic for a fixed lighting current

FIG. 7 shows schematically and exemplarily how the color points of the electroluminescent devices of FIG. 3 can be adjusted

FIG. 8 shows schematically and exemplarily a result of adjusting the color points of the electroluminescent devices of FIG. 3

FIG. 9 shows schematically and exemplarily an embodiment of a driver circuit for use with an electroluminescent device according to FIG. 1

FIG. 10 shows schematically and exemplarily an embodiment of a dual output driver circuit for use with an electroluminescent device according to FIG. 1

FIG. 11 shows exemplarily a flowchart illustrating an embodiment of a method for adjusting the color point of light emitted by an electroluminescent device

FIG. 12 shows schematically and exemplarily an embodiment of a lighting apparatus for generating light, and

FIG. 13 shows exemplarily a flowchart illustrating an embodiment of a method for generating light.

If a specific reference numeral is used in more than one of the drawings, it is intended to refer to the same element, device or unit.

### DETAILED DESCRIPTION OF EMBODIMENTS

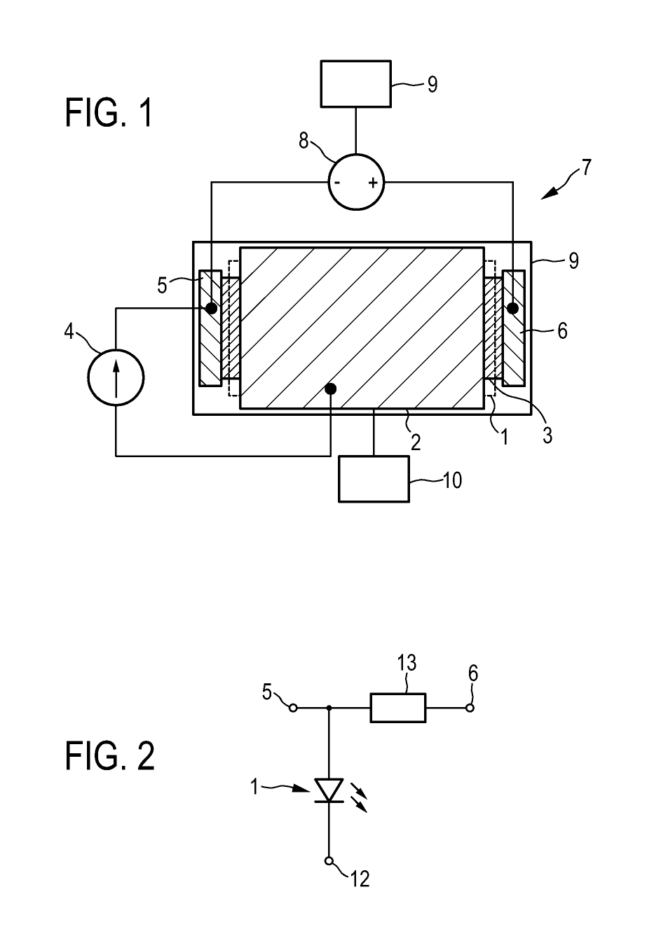

FIG. 1 shows schematically and exemplarily an embodiment of an electroluminescent device for emitting light having a adjustable color point, the electroluminescent device being, in this embodiment, an OLED (organic light emitting diode) device. The electroluminescent device comprises an electroluminescent region 1 and two electrodes 2, 3 for applying a lighting current through the electroluminescent region 1. The two electrodes 2, 3 may comprise, for example, a transparent conductive oxide, such as indium tin oxide (ITO). In this embodiment, the electroluminescent device is built in a layered structure, i.e., the electroluminescent region 1 as well as the electrodes 2, 3 are formed as layers and the electroluminescent region 1 is arranged between the two electrodes 2, 3. The electrode 2 that is shown on top of the electroluminescent region 1 in FIG. 1 is the cathode 2 and the electrode 3 that is shown below—and therefore partly hidden by—the electroluminescent region 1 is the anode 3, i.e., a lighting current that is applied by the electrodes 2, 3 through the electroluminescent region 1 flows from the cathode 2 to the anode 3. The layered structure formed by the electroluminescent region 1 and the electrodes 2, 3 is arranged on a substrate 9 such that the anode 3 faces the substrate 9.

The electroluminescent device further comprises a lighting current source 4, preferentially, a constant current source, that is electrically coupled to the electroluminescent region 1 via the two electrodes 2, 3, in this case, at the anode 3, via an additional anode contact 5. If the lighting current source 4 applies a lighting current through the electroluminescent region 1, the recombination of electrons with holes, during which process the electrons release energy in the form of photons, results in light being emitted by the electroluminescent region 1. The intensity of the emitted light, i.e., the quantity of the light quanta, depends on the amount of lighting current applied through the electroluminescent region 1. The color of the emitted light depends primarily on the materials chosen for the electroluminescent region.

In addition, the electroluminescent device comprises a heating element 7 for applying heat to the electroluminescent region 1 as well as a heating control unit 9 for controlling the heating element 7 in applying the heat in order to adjust the color point of the emitted light. The heating element 7, in this embodiment, comprises a heating power source 8 that is electrically coupled to the anode 3, in this case, via the additional anode contacts 5, 6. By means of the heating power source 8, a heating current can be applied through the anode 3, such that the heat resulting from conduction losses within the anode 3 changes the temperature of the electroluminescent region 1, and, therewith, adjusts the color point of the emitted light. Because the lighting current source 4 and the heating power source 8 only have the anode contact 5 in common, the flow of the heating current does not affect the flow of the lighting current.

The electroluminescent device, in this embodiment, comprises a temperature sensing element 10 for providing a sensed temperature of the electroluminescent region 1 to the heating control unit 9. The temperature sensing element 10, in this embodiment, is adapted to sense the temperature of the electroluminescent region 1 using a thermometer, such as a thermocouple or a similar device. In other embodiments, the temperature sensing element 10 can be adapted to sense the temperature of the electroluminescent region 1 by measuring for a given lighting current a voltage change across the electroluminescent region 1 and by relating it to the temperature of the electroluminescent region 1 depending on a voltage change vs. temperature characteristic of the electroluminescent region 1. This approach to sensing the temperature of the electroluminescent region 1 is also called “intrinsic sensing”.

The temperature sensing element 10 allows to provide the heating control unit 9 with a continous feedback about the temperature of the electroluminescent region 1. This makes it possible to provide a closed loop control of the heat that is applied to the electroluminescent region 1.

In particular, in this embodiment, in which the heating element 7 comprises a heating power source 8 electrically coupled to the anode 3 for applying a heating current through the anode 3, the heating control unit 9 can easily control the heating element 7 to apply a sufficient amount of heating current through the anode 3 so that a desired temperature of the electroluminescent region 1 is reached. It is, in this case, not necessary to have a-priori knowledge about the device specific relationship between the amount of heating current applied through the anode 3 and the temperature changes induced by it in the electroluminescent region 1.

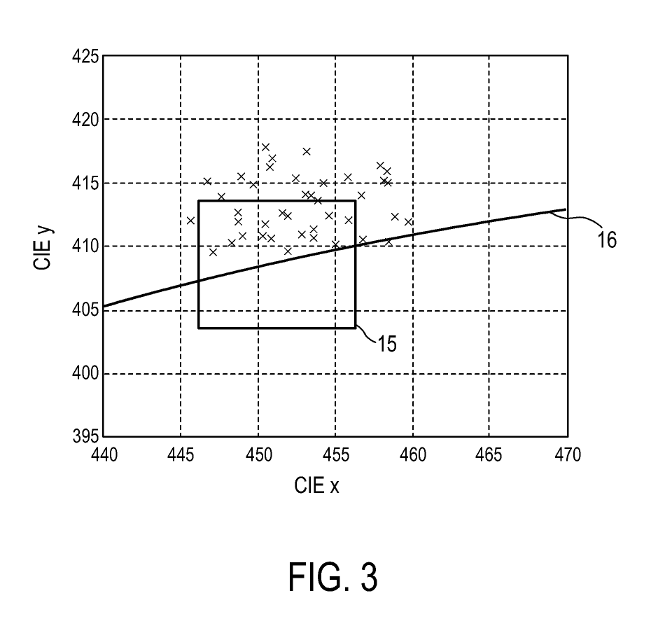

Furthermore, the heating control unit 9, in this embodiment, controls the heating element 7 in applying the heat depending on a temperature vs. color point characteristic of the electroluminescent region 1. Using the temperature vs. color point characteristic of the electroluminescent region 1, i.e., the characteristic that relates: 1) the temperature of the electroluminescent region 1, and; 2) the color point of the light emitted by the electroluminescent region 1 for a given lighting current, the feedback from the temperature sensing element 10 to the heating control unit 9 allows for a direct control of the color point by simply heating the electroluminescent region 1 until the temperature that corresponds to the desired color point is reached. This approach to adjusting the color point of the electroluminescent device will be described in more detail with reference to an example shown in FIGS. 3 to 8 below. In this example, the heating control unit 9 of the electroluminescent devices uses a linear temperature vs. color point relationship as the temperature vs. color point characteristic of the electroluminescent region 1.

FIG. 2 shows schematically and examplarily an equivalent circuit of the basic elements of an electroluminescent device according to FIG. 1. The figure shows the anode contacts 5, 6 via which the heating power source 8 (not shown in this figure) is coupled to the anode 3, which, in this illustration, is modelled as a square resistance 13. The figure further shows the electroluminescent region 1 as well as a cathode contact 12. The lighting current source 4 (not shown in this figure) is electrically coupled to the electroluminescent region 1 via the anode contact 5 and the cathode contact 12.

FIG. 3 shows schematically and exemplarily a color point distribution for a production batch of electroluminescent devices, in this case, white OLED devices. The small crosses mark the measured color points of different electroluminescent devices from the same production batch in a clipping of the CIE xy chromaticity diagram. The CIE xy chromaticity diagram is normally shown with units ranging from 0.0 to 0.8 in CIE x direction and from 0.0 to 0.9 in CIE y direction. In the clipping shown in FIG. 3 as well as in all following figures these units are scaled by a factor of thousand to enhance the readability.

The measured color points, in this example, vary slightly from one electroluminescent device to the other, with the largest differences in CIE x direction being about 15 scaled units and the largest differences in CIE y direction being about 10 scaled units. Only about 66% of the color points are within a desired color point target 15, which is defined, in this example, by a rectangular chromaticity window. Because the electroluminescent devices, in this example, are white OLED devices, the desired color point target 15, in this case, is situated next to the black body line 16.

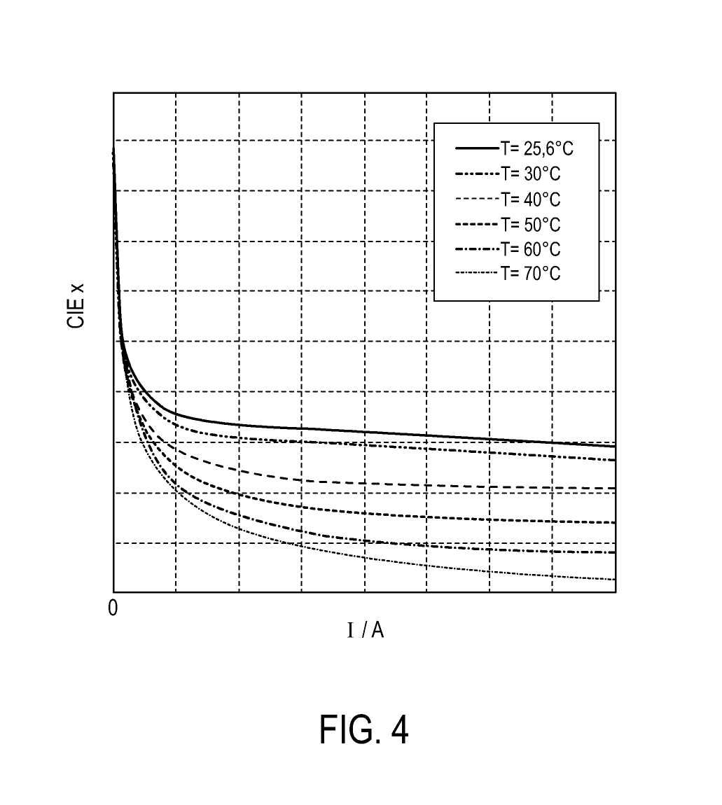

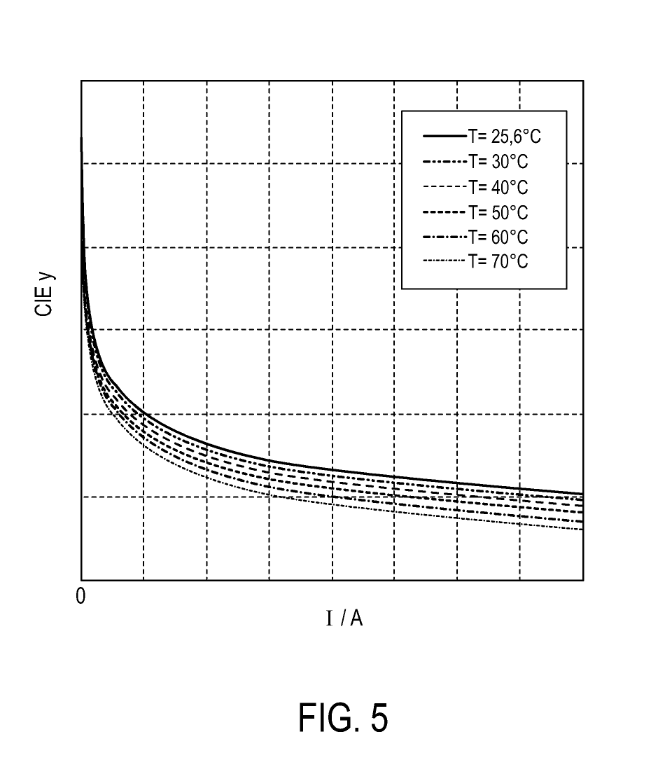

FIGS. 4 and 5 show schematically and exemplarily a temperature dependency of the color point for varying lighting currents. In more detail, each curve in FIGS. 4 and 5 represent the CIE x values, resp. the CIE y values, of the measured color point for a typical electroluminescent device, in this case, for a typical white OLED device, for a constant temperature of the electroluminescent region 1 and varying lighting currents applied through it. The figures show that for a fixed lighting current, the CIE x values, resp. the CIE y values, of the measured color point vary noticeably with the temperature of the electroluminescent region 1, with the amount of variation being larger in CIE x direction than in CIE y direction. Furthermore, it can be seen that for smaller lighting currents, the measured color point is, to some degree, also dependent on the lighting current itself, i.e., the amount of lighting current applied through the electroluminescent region 1 does not only determine the intensity of the emitted light, i.e., the quantity of the light quanta, but also slightly influences the color point. For larger lighting currents, however, the temperature dependency of the color point becomes more dominant than its dependency on the lighting current.

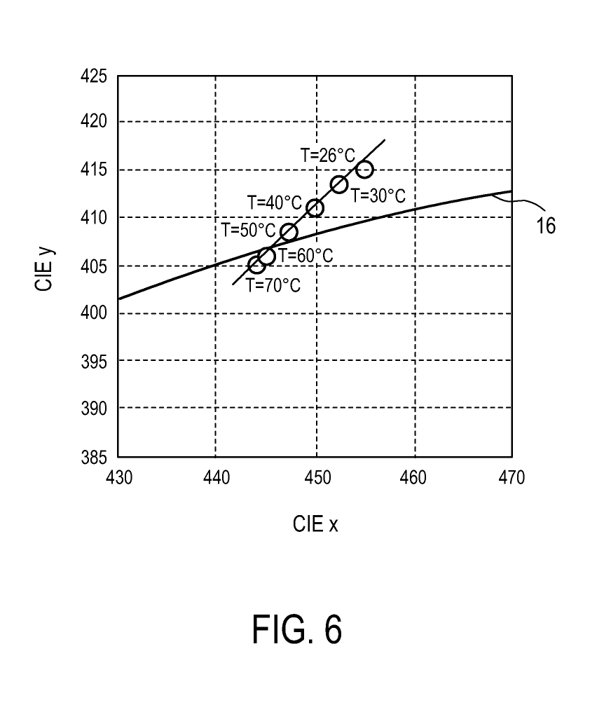

FIG. 6 shows schematically and exemplarily a temperature vs. color point characteristic for a fixed lighting current. In more detail, the filled circles represent the CIE xy values of the measured color point for a typical electroluminescent device, in this case, for a typical white OLED device, for varying temperatures of the electroluminescent region 1 and a constant lighting current applied through it. The figures shows that the temperature vs. color point characteristic, in this example, can quite well be approximated by a linear temperature vs. color point relationship of the form:

CIE x=slope_{y}·T+x₀,

CIE y=slope_{y}·T+y₀,

where T is the temperature of the electroluminescent region 1 and slopeₓ, slope_{y} are constants that are related to properties of the electroluminescent device, such as the size of the device, the materials that are used and the type of packaging. As such, they are usually substantially equal for all OLED devices in a production batch. In contrast, x₀, y₀ are typically different for different electroluminescent devices from the same production batch. This difference in x₀, y₀ is also the reason for the variation in the measured color points shown in FIG. 3.

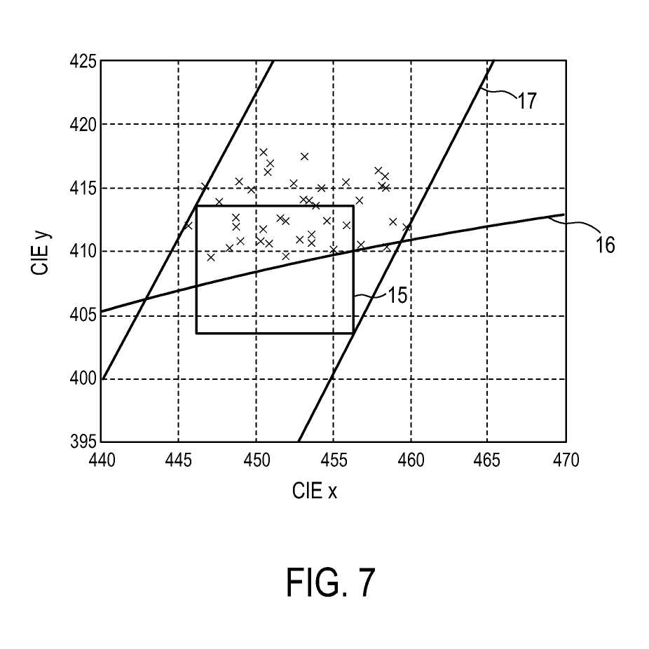

FIG. 7 shows schematically and exemplarily how the color points of the electroluminescent devices of FIG. 3, which are, in this case, white OLED devices, can, in principle, be adjusted. This is determined as described with reference to FIG. 5, i.e., the temperature vs. color point characteristic of the electroluminescent devices has been approximated by the described linear temperature vs. color point relationship, so that the color point of each OLED device can be adjusted along a straight adjustment line that is given by the constants slopeₛ, slopeₛ and that runs through the respective color point. The box 17 then illustrates a region within the CIE xy chromaticity diagram from which it can be seen if the color point of a given electroluminescent device can be adjusted to lie within the desired color point target 15. If the color point is located within the box 17 and above or to the right of the color point target 15 it can, otherwise, it cannot.

In more detail, if the color point of a given electroluminescent device is located outside the shaded area 17, it cannot be adjusted to lie within the color point target 15, because its adjustment line does not intersect with the color point target 15. If the color point of a given electroluminescent device is located below or to the left of the color point target 15, it cannot be adjusted to lie within the color point target 15, because the heating of the electroluminescent region 1 would only move the color point further away from the color point target 15.

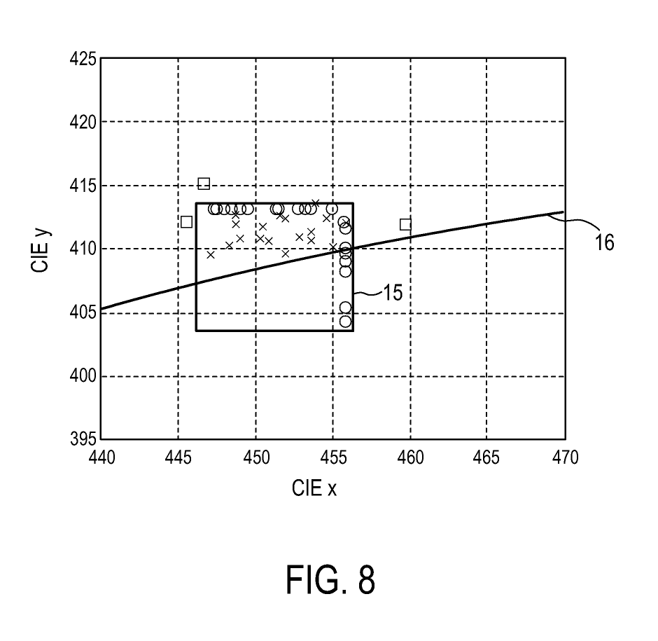

FIG. 8 shows schematically and exemplarily a result of adjusting the color points of the electroluminescent devices of FIG. 3, which are, in this case, white OLED devices. The color points have been adjusted, in this case, as described with reference to FIG. 7. The small circles mark the color points that could be adjusted to lie within the color target 15—after the adjustment. The three small squares mark the color points that could not be adjusted to lie within the color target 15, either because they are located outside the box 17 of FIG. 7 and, thus, their adjustment line does not intersect with the color point target 15—here the two squares located above and to the right of the color point target 15—, or because the heating of the electroluminescent region 1 would only move them further away from the color point target 15—here the square located to the left of the color point target.

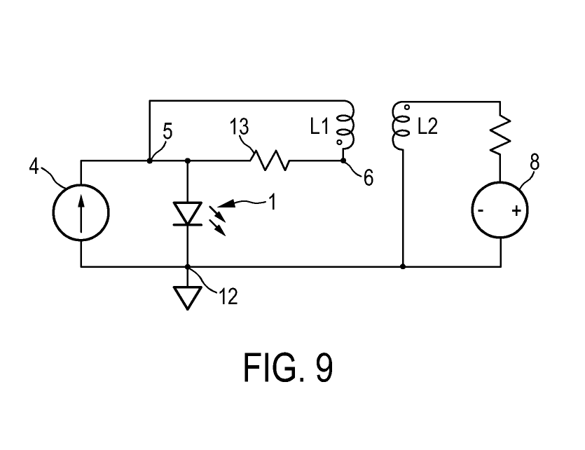

FIG. 9 shows schematically and exemplarily an embodiment of a driver circuit for use with an electroluminescent device according to FIG. 1. The figure shows the anode contacts 5, 6 via which the heating power source 8 is coupled to the anode 3, which, in this illustration, is modelled as a square resistance 13. The figure further shows the electroluminescent region 1 as well as a cathode contact 12. The lighting current source 4 is electrically coupled to the electroluminescent region 1 via the anode contact 5 and the cathode contact 12. The driver circuit according to this figure differs from the wiring shown in FIG. 1 in the following way: With the wiring shown in FIG. 1, both contacts of the heating power source 8, i.e., the anode contacts 5, 6, are floating with respect to the potential of the cathode 2 of the electroluminescent device. In cases where the heating power source 8 needs to have a common potential with the cathode 2, the driver circuit according to this figure can be used. It makes use of a dual winding transformer L1-L2, which has its secondary winding powered by the heating power source 8 and which has its primary winding electrically coupled to the anode contacts 5, 6. The heating power source 8, in this case, has to be an alternating current (AC) source.

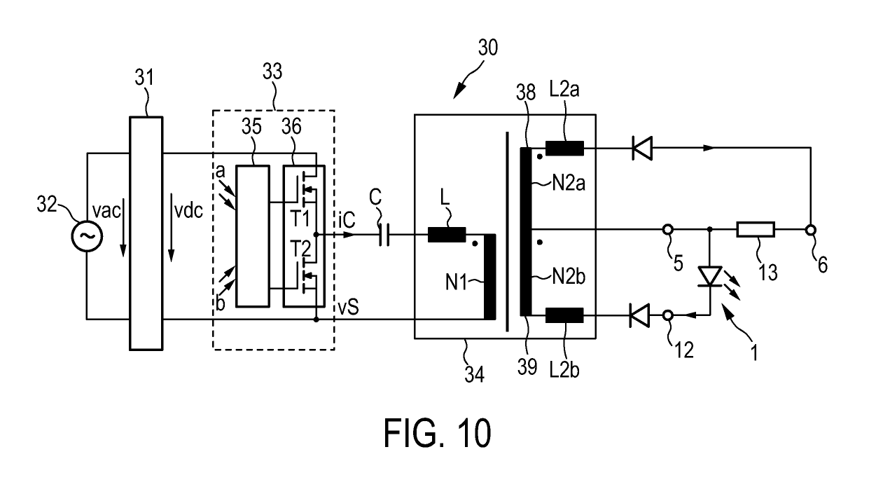

FIG. 10 shows schematically and exemplarily an embodiment of a dual output driver circuit 30 for use with an electroluminescent device according to FIG. 1. The dual output driver circuit 30 is described in more detail in U.S. Pat. No. 7,573,729 B2, which is herewith incorporated by reference, where it is used to control two LEDs or two groups of LEDs. In the dual output driver circuit 30 a rectifier and filter 31 are connected to alternating current (AC) power source 32 producing an alternating voltage vac. The direct voltage vdc present at the output of the rectifier 31 supplies a DC/AC converter 33 to which a transformer 34 is connected. A capacitor C is connected in series between the DC/AC converter 33 and the transformer 34. The capacitor C and the transformer 34 together form a resonant circuit. The DC/AC converter 33 is essentially based on a driver control 35 to which two transistors 36 arranged in a half bridge circuit are connected. Alternatively, the DC/AC converter 33 may also be constructed as a full bridge circuit. The transformer 34 has two outputs that provide two output voltages, which are individually adjustable by means of the driver control unit 35 and which are derived via respective inductances L2a and L2b between the connections 38 and 39 on the one hand and a central trap on the other hand. In this embodiment, one of the two outputs is electrically coupled to the anode 3—modelled, in this illustration, as a square resistance 13—of the electroluminescent device, in this case, via the anode contacts 5, 6. Alternatively, it could also be electrically coupled to the cathode 2. The other output is electrically coupled to the electroluminescent region 1 via the anode contact 5 and the cathode contact 12. By means of the driver control unit 35, the lighting current that is applied to the electroluminescent region 1 and the heating current that is applied to the anode 3 can be varied independently from each other. In particular, the driver control unit 35 can act as a heating control unit 9 and control the application of heat to the electroluminescent region 1. If the electroluminescent device comprises a temperature sensing element 10 (not shown in this figure), the temperature sensing element 10 can provide a sensed temperature of the electroluminescent region 1 to the driver control unit 35.

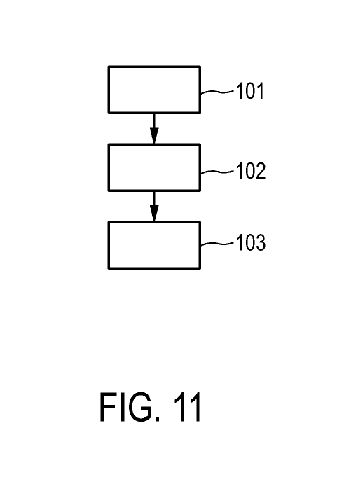

FIG. 11 shows exemplarily a flowchart illustrating an embodiment of a method for adjusting the color point of light emitted by an electroluminescent device. In step 101, light is emitted by an electroluminescent region lin response to a lighting current. In step 102, heat is applied to the electroluminescent region 1 by a heating element 7. In step 103, the heating element 7 is controlled by a heating control unit 9 in applying the heat in order to adjust the color point of the emitted light.

It is noted that these steps do not all have to be executed consecutively, but can be executed, at least in part, concurrently, i.e., at the same time. Preferentially, the electroluminescent region 1 emits light in response to a lighting current (step 101) while the heating element 7 applies heat to the electroluminescent region 1 (step 102). The heating control unit 9 therewhile controls the heating element 7 in applying the heat in order to adjust the color point of the emitted light (step 103).

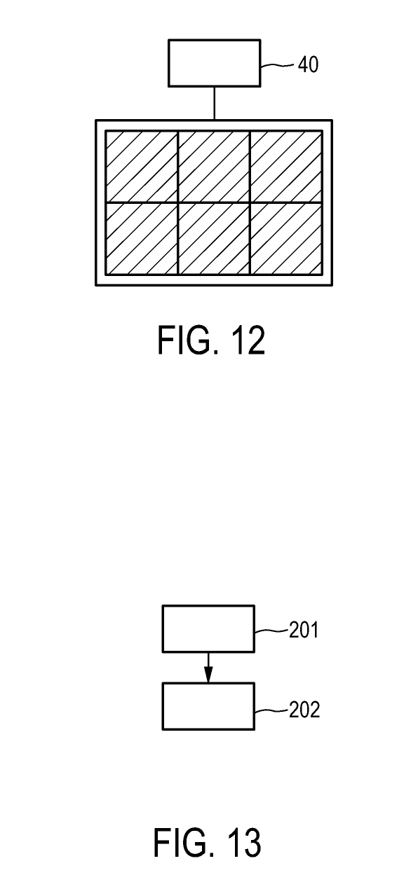

FIG. 12 shows schematically and exemplarily an embodiment of a lighting apparatus for generating light. The lighting apparatus comprises, in this embodiment, six electroluminescent devices for emitting light having an adjustable color point—illustrated by the six shaded squares—as described with reference to FIG. 1 above. The lighting apparatus further comprises a lighting apparatus control unit 40 for controlling the heating control unit 9 of at least one of the two or more electroluminescent devices in order to reduce a variation between the color points of the light emitted by the two or more electroluminescent devices.

Such a lighting apparatus has the advantage that small color point variations, which may exist even between different electroluminescent devices from the same production batch, may effectively be reduced.

FIG. 13 shows exemplarily a flowchart illustrating an embodiment of a lighting method for generating light. In step 201, light having an adjustable color point is emitted by two or more electroluminescent devices, each comprising an electroluminescent region 1 for emitting light in response to a lighting current, a heating element 7 for applying heat to the electroluminescent region 1, and a heating control unit 9 for controlling the heating element 7 in applying the heat in order to adjust the color point of the emitted light, as described, for example, with reference to FIG. 1. In step 202, the heating control unit 9 of at least one of the two or more electroluminescent devices is controlled by a lighting apparatus control unit 40 in order to reduce a variation between the color points of the light emitted by the two or more electroluminescent devices.

It is noted that these steps do not all have to be executed consecutively, but can be executed, at least in part, concurrently, i.e., at the same time. Preferentially, the two or more electroluminescent devices as defined in claim 1 emit light having an adjustable color point (step 201) while the lighting apparatus control unit 40 controls the heating control unit 9 of at least one of the two or more electroluminescent devices in order to reduce a variation between the color points of the light emitted by the two or more electroluminescent devices (step 202).

While the invention has been illustrated and described in detail in the drawings and foregoing description, such illustration and description are to be considered illustrative or exemplary and not restrictive; the invention is not limited to the disclosed embodiments.

In the embodiment of an electroluminescent device described with reference to FIG. 1, the heating power source 8 is coupled to the anode 3. In other embodiments, the heating power source 8 can also be coupled to the cathode 2. Moreover, it is also possible that both the electrodes 2, 3 are used for applying heat to the electroluminescent region 1. This could be realized, for example, by using a driver circuit with two separate outputs, wherein one of the outputs is electrically coupled to the anode 2 and the other is electrically coupled to the cathode 3. Such a driver circuit may be based on a transformer with a primary winding and two secondary windings, where the primary winding is electrically coupled to the heater power source 8 and each secondary winding is coupled to a respective electrode 2, 3. Also, it is possible to provide two separate heating power sources, one coupled to one of the two electrodes 2, 3 and the other one coupled to the other.

Although, in the embodiment of an electroluminescent device described with reference to FIG. 1, the heating power source 8 is coupled via the anode contacts 5, 6 to the short sides of the anode 3, which is of an elongated rectangular shape, the coupling could also be realized along the long sides of the anode 3.

Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

A computer program may be stored/distributed on a suitable medium, such as an optical storage medium or a solid-state medium, supplied together with or as part of other hardware, but may also be distributed in other forms, such as via the Internet or other wired or wireless telecommunication systems.

Any reference signs in the claims should not be construed as limiting the scope.

1. An electroluminescent device for emitting light having a adjustable color point, the electroluminescent device comprising:
an electroluminescent region for emitting light in response to a lighting current,
a heating element for applying heat to the electroluminescent region,
a heating control unit for controlling the heating element in applying the heat in order to adjust the color point of the emitted light.

2. The electroluminescent device according to claim 1, wherein the electroluminescent device comprises two electrodes for applying the lighting current through the electroluminescent region, wherein the heating element comprises a heating power source electrically coupled to one of the two electrodes for applying a heating current through that electrode in order to generate joule heat.

3. The electroluminescent device according to claim 2, wherein the electrodes have different electrical resistances, wherein the heating power source is electrically coupled to the electrode having the higher electrical resistance.

4. The electroluminescent device according to claim 1, wherein the heating control unit is adapted to control the heating element in applying the heat depending on a temperature relative to color point characteristic of the electroluminescent region.

5. The electroluminescent device according to claim 4, wherein the heating control unit uses a linear temperature vs. color point relationship as the temperature vs. color point characteristic of the electroluminescent region.

6. The electroluminescent device according to claim 1, wherein the electroluminescent device comprises a temperature sensing element for providing a sensed temperature of the electroluminescent region to the heating control unit.

7. The electroluminescent device according to claim 6, wherein the temperature sensing element is adapted to sense the temperature of the electroluminescent region using a thermometer.

8. The electroluminescent device according to claim 6, wherein the temperature sensing element is adapted to sense the temperature of the electroluminescent region by measuring for a given lighting current a voltage change across the electroluminescent region and by relating it to the temperature of the electroluminescent region depending on a voltage change relative to temperature characteristic of the electroluminescent region.

9. A method for adjusting the color point of light emitted by an electroluminescent device, the method comprising:
emitting light in response to a lighting current by an electroluminescent region,
applying heat to the electroluminescent region by a heating element,
controlling the heating element in applying the heat in order to adjust the color point of the emitted light by a heating control unit.

10. (canceled)

11. A lighting apparatus for generating light, the lighting apparatus comprising
two or more electroluminescent devices for emitting light having an adjustable color point as defined in claim 1,
a lighting apparatus control unit for controlling the heating control unit of at least one of the two or more electroluminescent devices in order to reduce a variation between the color points of the light emitted by the two or more electroluminescent devices.

12. A lighting method for generating light, the method comprising:
emitting light having an adjustable color point by two or more electroluminescent devices as defined in claim 1,
controlling the heating control unit of at least one of the two or more electroluminescent devices in order to reduce a variation between the color points of the light emitted by the two or more electroluminescent devices by a lighting apparatus control unit.

13. (canceled)
